(19) United States
(12) Patent Application Publication
(10) Pub. No.: US 2019/0022665 A1
(43) Pub. Date: Jan. 24, 2019

(54) Device for Magnetic Bead Resuspension

(71) Applicant: Dexter Magnetic Technologies, Inc., Elk Grove Village, IL (US)

(72) Inventors: Christian Kronshage, Round Lake, IL (US); Christopher A. Ras, St. Charles, IL (US); Bo Zhang, Lake Zurich, IL (US)

(21) Appl. No.: 16/042,845

(22) Filed: Jul. 23, 2018

Related U.S. Application Data
(60) Provisional application No. 62/536,277, filed on Jul. 24, 2017.

(51) Int. Cl. B03C 1/06; H01F 7/02; B03C 1/28

(52) U.S. Cl. CPC B03C 1/06; H01F 7/0236; B03C 2201/18; B03C 2201/22; B03C 1/28

(57) ABSTRACT

An apparatus for resuspending or maintaining suspension of magnetic beads in a reagent tray includes a di-pole magnet assembly disposed proximate the reagent tray. The di-pole magnet assembly inducing a static magnetic field having an amplitude gradient in a material disposed in the reagent tray. The di-pole magnet assembly magnetic field is movable with respect to the reagent tray. In some embodiments the magnetic field or the magnet assembly is movable linearly, rotationally or both linearly and rotationally with respect to the reagent tray.

### CROSS REFERENCE TO RELATED APPLICATIONS

Priority is claimed from U.S. Provisional Application No. 62/536,277 filed on Jul. 24, 2018, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of apparatus used for the resuspension of magnetic beads in a reagent trough in biological testing.

The use of high gradient magnetic fields for the separation of particles is commonplace in the fields of biology, biotechnology, and other bio-medical fields. Target particles, comprising entities such as proteins and the like, may be separated from a solution by the use of magnetic beads. The magnetic beads are stored in an open trough until they are transferred via pipette to the microtiter tray used to run the test (assay). During this time, which can last several minutes, the magnetic beads may fall out of suspension. Thus, when the magnetic beads are aspirated into the pipette, the concentration magnetic beads may be incorrect, which could adversely affect the assay results. In addition, the magnetic beads may be resuspended by other methods, such as shaking or mixing using the pipette tips, which can provide inconsistent results and increase overall assay time.

### SUMMARY

An apparatus according to one aspect of the disclosure for resuspending or maintaining suspension of magnetic beads in a reagent tray includes a di-pole magnet assembly disposed proximate the reagent tray. The di-pole magnet assembly induces a static magnetic field having an amplitude gradient in a material disposed in the reagent tray. A magnetic field induced by the di-pole magnet assembly is movable with respect to the reagent tray.

In some embodiments, the di-pole magnet assembly is mounted on a movable carriage, wherein the movable carriage enables motion of the di-pole magnetic assembly along a length of the reagent tray.

In some embodiments, the movable carriage is movable linearly with respect to the reagent tray.

In some embodiments, the movable carriage is movable linearly and rotationally with respect to the reagent tray.

In some embodiments, the movable carriage is movable rotationally with respect to the reagent tray.

In some embodiments, the apparatus is self-contained and fits on a laboratory bench.

In some embodiments, the apparatus is mounted to a deck of an automated liquid handling system.

In some embodiments, the di-pole magnet assembly comprises at least one of a hallbach magnet assembly and a quadrature magnet assembly.

In some embodiments, the magnet assembly is movable and the movement of the magnet assembly is automated.

In some embodiments, the automated movement of the magnet assembly is electronically controlled.

In some embodiments, the automated, electronically controlled movement of the magnet assembly is integrated into an automated liquid handling system.

In some embodiments, the magnet assembly comprises at least one permanent magnet.

In some embodiments, the magnet assembly comprises at least one electromagnet.

In some embodiments, the electromagnet is operated by direct current, alternating current or combinations thereof.

In some embodiments, the operating current is selected to induce a static magnetic field corresponding to movement of the magnet assembly with respect to the reagent tray.

In some embodiments, the magnet assembly is movable with respect to the reagent tray.

### BRIEF DESCRIPTION OF THE DRAWINGS

FIG. 1 shows an example embodiment of an apparatus according to the present disclosure.

### DETAILED DESCRIPTION

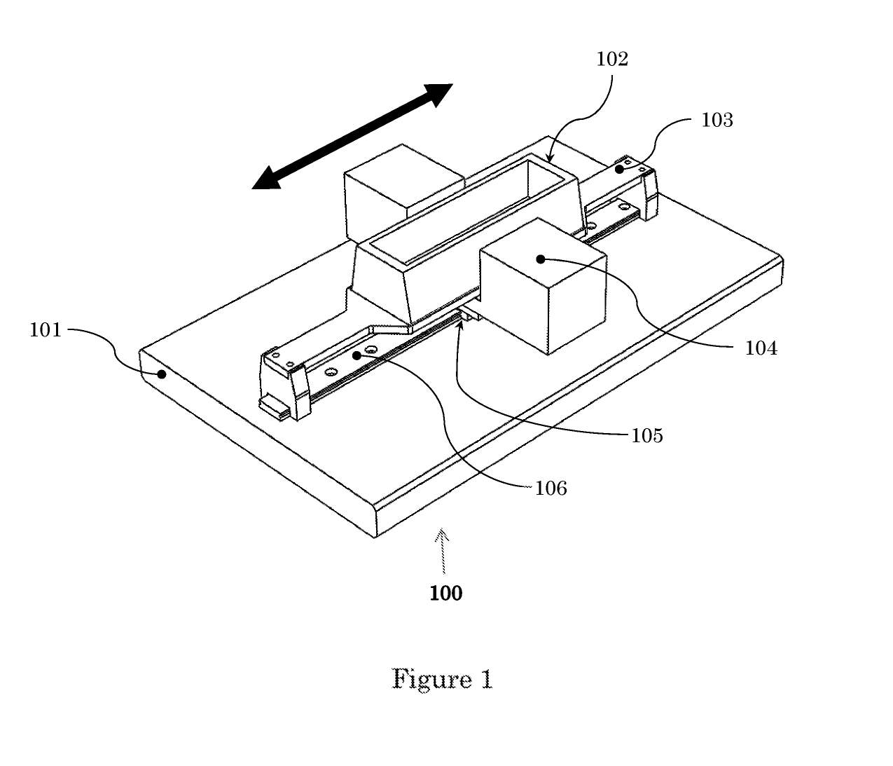

An example embodiment of an apparatus according to the present disclosure. Is shown in FIG. 1.

The apparatus (100) includes a base (101), which holds a reagent tray (102) containing magnetic beads in suspension. The reagent tray (102) may be supported by a mounting bracket (103). A di-pole magnet assembly (104) in the present example embodiment is mounted to a carriage (105) that is movable axially along a track (106) affixed to of formed in the base (101). The magnet assembly (104) is oriented transversely to the reagent tray (102) and imparts a magnetic field having an amplitude gradient onto the magnetic beads in suspension. As the magnet (104) is moved back and forth with reference to the reagent tray (102), the magnetic field and field gradient moves with the magnet (104), causing agitation of the beads (not shown). Such agitation results in the mixing of the magnetic beads into suspension in the reagent tray (102).

In some embodiments, the magnet assembly (104) may comprise permanent magnets. In some embodiments, the magnet assembly (104) may comprise electromagnets. In embodiments comprising electromagnets, the electromagnets may be operated using direct current (DC). Some embodiments using electromagnets may use alternating current (AC) or AC superimposed on DC. AC and AC superimposed on DC embodiments may comprise varying the current amplitude and/or frequency to simulate movement of the magnet assembly (104) with respect to the reagent tray (102).

The apparatus (100) in some embodiments may be self-contained and can fit on a laboratory bench, for use with manual assays. In some embodiments, the apparatus (100) can be mounted to the deck of a liquid handling system for use in automated assay.

In some embodiments, the apparatus (100) may use different type of magnet assemblies, including without limitation, hallbach and quadrature magnet assemblies.

In some embodiments, movement of the magnet assembly (104) may be automated. In some embodiments, the automated movement of the magnet assembly (104) may be electronically controlled. In some embodiments, the automated, electronically controlled movable magnet assembly (104) may be integrated into an automated liquid handling system. Example embodiments of such automated liquid handling systems include ones sold by Tecan Group Ltd., Seestrasse 103, 8708 Männedorf, Switzerland under the registered trademark FREEDOM EVO. Other example embodiments are sold by Hamilton Robotics, 4970 Energy Way Reno, Nev., 89502 U.S.A, under the trademark MICROLAB VANTAGE. Other such systems will occur to those skilled in the art.

In some embodiments, an apparatus to resuspend or to keep magnetic beads suspended in a reagent tray may have a magnet assembly arranged for rotary motion around the reagent tray. In some embodiments, the di-pole magnet assembly (104) may be disposed on a movable carriage as shown in FIG. 1, in combination with rotary motion around the reagent tray (102).

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. An apparatus for resuspending or maintaining suspension of magnetic beads in a reagent tray, comprising:
a di-pole magnet assembly disposed proximate the reagent tray, the di-pole magnet assembly inducing a static magnetic field having an amplitude gradient in a material disposed in the reagent tray;
wherein a magnetic field induced by the the di-pole magnet assembly is movable with respect to the reagent tray.

2. The apparatus of claim 1 wherein the di-pole magnet assembly is mounted on a movable carriage, wherein the movable carriage enables motion of the di-pole magnetic assembly along a length of the reagent tray.

3. The apparatus of claim 2 wherein the movable carriage is movable linearly with respect to the reagent tray.

4. The apparatus of claim 2 wherein the movable carriage is movable linearly and rotationally with respect to the reagent tray.

5. The apparatus of claim 2 wherein the movable carriage is movable rotationally with respect to the reagent tray.

6. The apparatus of claim 1 wherein the apparatus is self-contained and fits on a laboratory bench.

7. The apparatus of claim 1 wherein the apparatus is mounted to a deck of an automated liquid handling system.

8. The apparatus of claim 1 wherein the di-pole magnet assembly comprises at least one of a hallbach magnet assembly and a quadrature magnet assembly.

9. The apparatus of claim 1, wherein the magnet assembly is movable and the movement of the magnet assembly is automated.

10. The apparatus of claim 9, wherein the automated movement of the magnet assembly is electronically controlled.

11. The apparatus of claim 7 wherein the automated, electronically controlled movement of the magnet assembly is integrated into an automated liquid handling system.

12. The apparatus of claim 1 wherein the magnet assembly comprises at least one permanent magnet.

13. The apparatus of claim 1 wherein the magnet assembly comprises at least one electromagnet.

14. The apparatus of claim 13 wherein the electromagnet is operated by direct current, alternating current or combinations thereof.

15. The apparatus of claim 14 wherein the operating current is selected to induce a static magnetic field corresponding to movement of the magnet assembly with respect to the reagent tray.

16. The apparatus of claim 1 wherein the magnet assembly is movable with respect to the reagent tray.
